(19) United States
(12) Patent Application Publication
(10) Pub. No.: US 2024/0140694 A1
(43) Pub. Date: May 2, 2024

(54) EXCREMENT TREATMENT MATERIAL AND METHOD FOR MANUFACTURING THE SAME

(71) Applicant: DAIKI CO., LTD., Tokyo (JP)

(72) Inventor: Junji YOSHINAGA, Tokyo (JP)

(73) Assignee: DAIKI CO., LTD., Tokyo (JP)

(21) Appl. No.: 18/406,433

(22) Filed: Jan. 8, 2024

Related U.S. Application Data
(63) Continuation of application No. PCT/JP2022/019631, filed on May 9, 2022.

(30) Foreign Application Priority Data
Aug. 4, 2021 (JP) 2021-127904

(51) Int. Cl. B65D 88/16; B09B 3/24

(52) U.S. Cl. CPC B65D 88/165; B09B 3/24; B09B 2101/018

(57) ABSTRACT

An excrement treatment material includes a plurality of grains, and a packaging bag. The plurality of grains are grains for treating excrement. The plurality of grains are housed in the packaging bag. A charge amount of an inner surface of the packaging bag is larger than a charge amount of an outer surface of the packaging bag.

### CROSS REFERENCE TO RELATED APPLICATION

This is a Continuation of International Application No. PCT/JP2022/019631 filed May 9, 2022, which claims the benefit of Japanese Application No. 2021-127904 filed Aug. 4, 2021. The contents of these applications are hereby incorporated by reference in their entirety.

### TECHNICAL FIELD

The present invention relates to an excrement treatment material and a method for manufacturing the same.

### BACKGROUND ART

A conventional excrement treatment material is disclosed in, for example, Patent Document 1. The excrement treatment material disclosed in Patent Document 1 includes a plurality of grains that absorb and treat animal or human excrement. These grains are shipped in a state of being housed collectively in one packaging bag.

### CITATION LIST

### Patent Document

Patent Document 1: JP 2010-158253 A

### SUMMARY OF INVENTION

### Technical Problem

Housing the plurality of grains in a packaging bag in this way contributes to convenience for transportation, storage, or the like of the excrement treatment material. However, a part of each grain is sometimes peeled during transportation, or the like due to the grains colliding with each other, for example. The peeled part becomes fine particles and accumulates in the packaging bag. For that reason, there has been a problem that the fine particles are released outside the packaging bag together with the grains when the grains are taken out from the opened packaging bag.

### Solution to Problem

The present invention has been made in view of the above-described problem, and it is an object thereof to provide an excrement treatment material in which fine particles accumulating in a packaging bag are unlikely to be released outside the packaging bag, and a method for manufacturing the same.

An excrement treatment material according to the present invention includes: a plurality of grains for treating excrement; and a packaging bag in which the plurality of grains are housed, wherein a charge amount of an inner surface of the packaging bag is larger than a charge amount of an outer surface of the packaging bag.

In this excrement treatment material, the packaging bag is provided in which the charge amount of the inner surface is larger than the charge amount of the outer surface. Even in a case where a part of the grain housed in the packaging bag is peeled to become fine particles, the fine particles are likely to be sucked on the inner surface of the packaging bag by making the charge amount of the inner surface of the packaging bag large in this way. For this reason, the fine particles become less likely to be released outside the packaging bag when the grains are taken out from the opened packaging bag.

A method for manufacturing an excrement treatment material according to the present invention includes: a grain forming step of forming a plurality of grains for treating excrement; and a grain housing step of housing the plurality of grains formed in the grain forming step in a packaging bag, wherein a charge amount of an inner surface of the packaging bag is larger than a charge amount of an outer surface of the packaging bag.

In this manufacturing method, the packaging bag is used in which the charge amount of the inner surface is larger than the charge amount of the outer surface. Even in a case where a part of the grain housed in the packaging bag is peeled to become fine particles in the manufactured excrement treatment material, the fine particles are likely to be sucked on the inner surface of the packaging bag by making the charge amount of the inner surface of the packaging bag large in this way. For this reason, the fine particles become less likely to be released outside the packaging bag when the grains are taken out from the opened packaging bag.

### Advantageous Effects of Invention

According to the present invention, it is possible to implement an excrement treatment material in which fine particles accumulating in a packaging bag are unlikely to be released outside the packaging bag, and a method for manufacturing the same.

### BRIEF DESCRIPTION OF DRAWINGS

FIG. 1 is a plane view showing an embodiment of an excrement treatment material according to the present invention.

FIG. 2 is a schematic view showing a grain 10.

### DESCRIPTION OF EMBODIMENTS

Hereinafter, an embodiment of the present invention will be described in detail with reference to the drawings. In the description of the drawings, the same elements are given the same reference numerals, and a redundant description will be omitted.

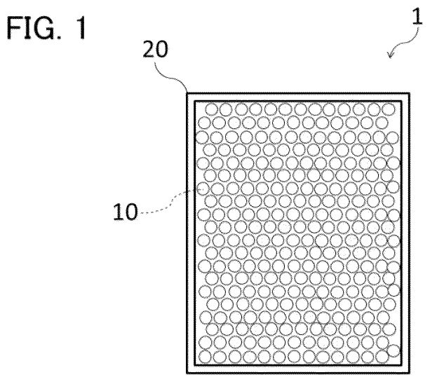

FIG. 1 is a plane view showing an embodiment of an excrement treatment material according to the present invention. An excrement treatment material 1 is an excrement treatment material used for treating animal or human excrement, and includes a plurality of grains 10, and a packaging bag 20. In FIG. 1, for ease of viewing, the packaging bag 20 is made transparent, and the inside thereof is shown. The packaging bag 20 may be transparent actually, or may be opaque.

The plurality of grains 10 are grains for treating excrement. Each grain 10 is configured to guide excrement inside the grain 10. In the present embodiment, the grains 10 have a water absorbing property, and treat excrement by absorbing the excrement. The grains 10 having the water absorbing property require the liquid passing rate of less than 60% measured by the following test. First, approximate 50 grams of the grains 10 (sample) are placed in a sieve with the inner diameter of 10 cm and the mesh size of 1 mm. An empty beaker is set under the sieve. Then, 30 ml of water is dripped on the sample over 10 seconds using a syringe with the inner diameter of its outer cylinder of 3 cm and the inner diameter of its cylinder tip of 4 mm (60 ml syringe manufactured by Terumo Corp.). After waiting 1 minute, the quantity of the water in the beaker is measured. The ratio of the measured water quantity with respect to the quantity of the dripped water (30 ml) shall be the liquid passing rate. That is, if the water quantity in the beaker is less than 18 ml, the liquid passing rate is less than 60%, and therefore the grains 10 are found to have the water absorbing property.

The particle diameter of each grain 10 is, for example, between 5 mm and 20 mm inclusive. As used herein, the particle diameter of each grain 10 is defined as the diameter of the minimum sphere that can include the grain 10. The excrement treatment material 1 is used, for example, in a state in which the plurality of grains 10 are laid in a box-shaped toilet.

Each grain 10 contains an organic substance as its main material. As used herein, the main material of each grain 10 refers to one of the material(s) constituting the grain 10 that accounts for the highest weight ratio in the grain 10. As the organic substance, for example, papers, used tea leaves, plastics, or bean curd lees can be used. Each grain 10 may be made only of an organic substance, or may be made of an organic substance and an inorganic substance.

The papers refer to a material made mainly of pulp. Examples of the papers include, in addition to ordinary paper, a vinyl chloride wallpaper classified product (paper obtained by classifying vinyl chloride wallpaper), fluff pulp, papermaking sludge, and pulp sludge. As the plastics, for example, a disposable diaper classified product (plastic obtained by classifying disposable diapers) may be used. The bean curd lees are preferably dried bean curd lees.

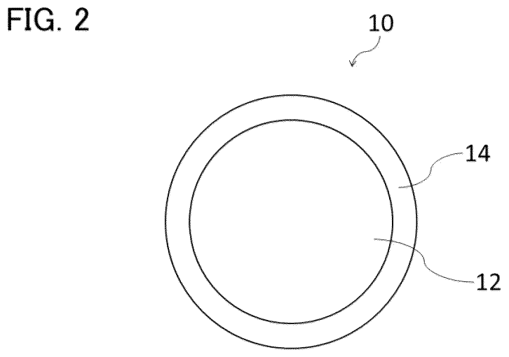

FIG. 2 is a schematic view showing the grain 10. Each grain 10 includes a core portion 12 and a coating portion 14. The core portion 12 is formed in a granular shape. Examples of the granular shape include a column, sphere, and ellipsoid. The core portion 12 has a function of absorbing and retaining excrement (particularly urine). The core portion 12 contains an organic substance as its main material. The core portion 12 may or may not contain an adhesive material. As the adhesive material, for example, a water-absorbent polymer, starch, CMC (carboxymethyl cellulose), PVA (polyvinyl alcohol), or dextrin can be used. The water-absorbent polymer is, for example, sodium polyacrylate.

The coating portion 14 covers the core portion 12. The coating portion 14 may cover the entire surface of the core portion 12, or may cover only a part of the surface of the core portion 12. The coating portion 14 has a function of bonding the grains 10 that have absorbed excrement to agglomerate them when in use. The coating portion 14 contains an adhesive material. The coating portion 14 also contains an organic substance as its main material.

Returning to FIG. 1, the plurality of grains 10 are housed in the packaging bag 20. The charge amount of the inner surface (surface facing the grains 10) of the packaging bag 20 is larger than the charge amount of the outer surface (surface exposed outside the packaging bag 20) of the packaging bag 20. The charge amount of the inner surface of the packaging bag 20 is preferably twice or more, and more preferably five times or more of the charge amount of the outer surface of the packaging bag 20. Also, it is preferable that a large part (a part, the area of which is more than 50% of the area of the entire inner surface) of the inner surface of the packaging bag 20 is in a charged state, and it is especially preferable that the entirety of the inner surface of the packaging bag 20 is in a charged state. The inner surface of the packaging bag 20 may be charged positively, or may be charged negatively. The charge amount of the inner surface of the packaging bag 20 is preferably 2 kV or more, and more preferably 5 kV or more.

The charge amount of the outer surface of the packaging bag 20 is preferably 1 kV or less. The outer surface of the packaging bag 20 may be in a charged state, or may not be in a charged state. In the former case, the outer surface of the packaging bag 20 may be charged positively, or may be charged negatively. In the latter case, it follows that the charge amount of the outer surface of the packaging bag 20 is zero. Note that the case where the inner surface of the packaging bag 20 is in a charged state (the charge amount>0) and the outer surface of the packaging bag 20 is not in a charged state (the charge amount=0) shall be included in the case where “the charge amount of the inner surface is five times or more of the charge amount of the outer surface”.

In the present embodiment, plastic such as polyethylene is used as the material of the packaging bag 20. Moreover, the packaging bag 20 is composed of two sheets (plastic sheets), the peripheral parts of which are stuck to each other. The packaging bag 20 is sealed by sticking the peripheral parts of the two sheets in this way. Each sheet may have single-layer structure composed only of one plastic film, or may have multi-layer structure in which a plurality of plastic films are laminated. In the latter case, the plurality of plastic films may be made of the same plastic material, or may be made of mutually different plastic materials.

Next, an example of a method for manufacturing the excrement treatment material 1 will be described as an embodiment of a method for manufacturing an excrement treatment material according to the present invention. This manufacturing method includes a grain forming step, an electrifying treatment step, and a grain housing step.

The grain forming step is a step of forming the plurality of grains 10. This step includes a core portion forming step and a coating portion forming step. The core portion forming step is a step of forming a plurality of the core portions 12. In the core portion forming step, granules that will serve as the core portions 12 are formed by granulating a granulating material (one or more materials constituting the core portion 12) with a granulation apparatus. Prior to the granulation, pretreatment such as pulverization, kneading, and adding water is performed on the granulating material as needed. As the granulation apparatus, for example, an extrusion granulator can be used.

The coating portion forming step is a step of forming the coating portion 14 so as to cover each core portion 12 formed in the core portion forming step. In the coating portion forming step, the coating portion 14 is formed by attaching a powdery coating material (one or more materials constituting the coating portion 14) to the surface of each core portion 12 with a coating apparatus or the like. The coating material can be attached by, for example, sprinkling or spraying. After that, posttreatment such as sieving, and drying is performed as needed. Thus, the plurality of grains 10 are obtained.

The electrifying treatment step is a step of electrifying the packaging bag 20 such that the charge amount of the inner surface is larger than the charge amount of the outer surface. This step is performed before the grain housing step. In the electrifying treatment step, for example, the inner surface of the packaging bag 20 is subjected to electrifying treatment, and thereby charged with static electricity. At this time, the outer surface of the packaging bag 20 may be or may not be subjected to electrifying treatment. For example, a corona electrifying method or a friction electrifying method can be used for the electrifying treatment. The electrifying treatment may be performed before the packaging bag 20 is formed (before the two sheets constituting the packaging bag 20 are stuck to each other), or may be performed after the packaging bag 20 is formed.

In the electrifying treatment step, it is preferable that the packaging bag 20 is electrified such that the charge amount of the inner surface is twice or more of the charge amount of the outer surface, and it is more preferable that the packaging bag 20 is electrified such that the charge amount of the inner surface is five times or more of the charge amount of the outer surface. In the electrifying treatment step, the inner surface of the packaging bag 20 may be electrified positively, or may be electrified negatively. In the electrifying treatment step, it is preferable that the packaging bag 20 is electrified such that the charge amount of the inner surface is 2 kV or more, and it is more preferable that the packaging bag 20 is electrified such that the charge amount of the inner surface is 5 kV or more. Also, it is preferable that the packaging bag 20 is electrified such that the charge amount of the outer surface is 1 kV or less.

The grain housing step is a step of housing the plurality of grains 10 formed in the grain forming step in the packaging bag 20. The packaging bag 20 is one that has been subjected to the electrifying treatment in the electrifying treatment step. In the grain housing step, a predetermined amount (e.g. 7 liters) of the grains 10 is housed in the packaging bag 20 in a state that the upper end portion of the packaging bag 20 is open with a filling machine or the like. After that, the packaging bag 20 is sealed by closing the upper end portion of the packaging bag 20. Accordingly, the excrement treatment material 1 is obtained.

Advantageous effects of the present embodiment will be described. In the present embodiment, the packaging bag 20 is used in which the charge amount of the inner surface is larger than the charge amount of the outer surface. Even in a case where a part of the grain 10 housed in the packaging bag 20 is peeled to become fine particles, the fine particles are likely to be sucked on the inner surface of the packaging bag 20 due to electrostatic force by making the charge amount of the inner surface of the packaging bag 20 large in this way. For this reason, the fine particles become less likely to be released outside the packaging bag 20 when the grains 10 are taken out from the opened packaging bag 20. Accordingly, the excrement treatment material 1 in which fine particles accumulating in the packaging bag 20 are unlikely to be released outside the packaging bag 20, and the method for manufacturing the same are implemented.

On the other hand, dust in the air can be unlikely to adhere to the outer surface of the packaging bag 20 by making the charge amount of the outer surface small.

In this way, the charge amount of the inner surface is preferably large, while the charge amount of the outer surface is preferably small in the packaging bag 20. From this viewpoint, the charge amount of the inner surface is preferably twice or more, and more preferably five times or more of the charge amount of the outer surface.

The electrifying treatment step in which the packaging bag 20 is electrified is performed before the grain housing step. By performing this electrifying treatment step, the packaging bag 20 can be electrified on a desired condition (difference in the charge amounts between the inner surface and the outer surface, positive/negative charge of each surface, the charge amount of each surface, and the like).

The broader a part in a charged state of the inner surface of the packaging bag 20 is, the more a large number of fine particles become likely to be sucked on the inner surface. From this viewpoint, it is preferable that a large part of the inner surface of the packaging bag 20 is in a charged state, and it is especially preferable that the entirety of the inner surface of the packaging bag 20 is in a charged state.

In the case where the inner surface of the packaging bag 20 is charged negatively, it is possible to easily implement the packaging bag 20, the inner surface of which is in a charged state. That is because plastic used as the material of the packaging bag 20 has a property of being easily charged negatively.

The larger the charge amount of the inner surface of the packaging bag 20 is, the higher the effect of sucking the fine particles becomes. From this viewpoint, the charge amount of the inner surface is preferably 2 kV or more, and more preferably 5 kV or more. On the other hand, if the charge amount is too large, it may become difficult to electrify the inner surface of the packaging bag 20 to a desired charge amount. From this viewpoint, the charge amount of the inner surface of the packaging bag 20 is preferably 100 kV or less.

The smaller the charge amount of the outer surface of the packaging bag 20 is, the higher the effect of preventing the dust from adhering becomes. From this viewpoint, the charge amount of the outer surface is preferably 1 kV or less.

Each grain 10 contains an organic substance as its main material. Thus, it is possible to obtain the grains 10 suitable for being disposed of by incineration. If the grains 10 are suitable for being disposed of by incineration in this way, the excrement treatment material 1 after use can be disposed of as burnable garbage, which therefore increases convenience for users. In the case where each grain 10 is made only of the organic substance, it is possible to obtain the grains 10 particularly suitable for being disposed of by incineration.

In the case where each grain 10 contains papers as its main material, fine particles generated from the grain 10 are also made mainly of papers. Papers have a property of easily adhering to charged plastic. Therefore, using papers as the main material of each grain 10 is advantageous for enhancing the sucking effect of the inner surface of the packaging bag 20 to the fine particles.

Each grain 10 includes the core portion 12 and the coating portion 14. In the grain 10 configured in this way, fine particles are likely to be generated due to the surface layer namely the coating portion 14 being peeled. Therefore, the excrement treatment material 1 in which the fine particles can be sucked on the inner surface of the packaging bag 20 is particularly useful.

Each grain 10 is configured to guide excrement inside the grain 10. In a case where such a grain 10 is formed, the granulating material is granulated with a relatively low pressure. That is because it is possible to secure many gaps that serve as paths for excrement in the grain 10 by lowering the pressure in granulation. On the other hand, because lowering the pressure in granulation makes the grain 10 fragile, fine particles are likely to be generated due to a part of the grain 10 being peeled. Therefore, the excrement treatment material 1 in which the fine particles can be sucked on the inner surface of the packaging bag 20 is particularly useful.

The present invention is not limited to the above-described embodiment, and various modifications can be made. In the above-described embodiment, an example is given in which plastic is used as the material of the packaging bag 20. However, a material other than plastic may be used as the material of the packaging bag 20.

In the above-described embodiment, an example is given in which each grain 10 contains an organic substance as its main material. However, each grain 10 may contain an inorganic substance as its main material.

In the above-described embodiment, an example is given in which each grain 10 is composed of the core portion 12 and the coating portion 14. However, it is not essential to provide the coating portion 14. That is, the grain 10 may be composed only of the core portion 12. In that case, it is preferable that the core portion 12 contains an adhesive material.

In the above-described embodiment, an example is given in which the grains 10 treat excrement by absorbing the excrement. However, the grains 10 may have a hydrophobic property, and treat excrement by allowing the excrement to pass. The grains having the hydrophobic property require the liquid passing rate of 60% or more measured by the test described above. In a case where such hydrophobic grains 10 are used, excrement passes through the gaps between the grains 10 to flow downward.

In the above-described embodiment, an example is given in which the electrifying treatment step is performed. However, it is not essential to perform the electrifying treatment step. In a case where the electrifying treatment step is not performed, for example, the packaging bag 20 charged in advance may be used in the grain housing step.

### LIST OF REFERENCE NUMERALS

1 Excrement Treatment Material
10 Grain
12 Core Portion
14 Coating Portion
20 Packaging Bag

1. An excrement treatment material comprising:
a plurality of grains for treating excrement; and
a packaging bag in which the plurality of grains are housed,
wherein a charge amount of an inner surface of the packaging bag is larger than a charge amount of an outer surface of the packaging bag.

2. The excrement treatment material according to claim 1,
wherein the charge amount of the inner surface is twice or more of the charge amount of the outer surface.

3. The excrement treatment material according to claim 1,
wherein the inner surface is charged negatively.

4. The excrement treatment material according to claim 1,
wherein the charge amount of the inner surface is 2 kV or more.

5. The excrement treatment material according to claim 1,
wherein the charge amount of the outer surface is 1 kV or less.

6. The excrement treatment material according to claim 1,
wherein each of the grains contains an organic substance as a main material.

7. The excrement treatment material according to claim 6,
wherein each of the grains is made only of the organic substance.

8. The excrement treatment material according to claim 6,
wherein each of the grains contains papers as the main material.

9. The excrement treatment material according to claim 1,
wherein each of the grains includes a core portion that is formed in a granular shape, and a coating portion that covers the core portion.

10. The excrement treatment material according to claim 1,
wherein each of the grains guides the excrement inside the grain.

11. A method for manufacturing an excrement treatment material, the method comprising:
a grain forming step of forming a plurality of grains for treating excrement; and
a grain housing step of housing the plurality of grains formed in the grain forming step in a packaging bag,
wherein a charge amount of an inner surface of the packaging bag is larger than a charge amount of an outer surface of the packaging bag.

12. The method for manufacturing an excrement treatment material according to claim 11, the method further comprising:
an electrifying treatment step of electrifying the packaging bag before the grain housing step such that the charge amount of the inner surface is larger than the charge amount of the outer surface.

13. The method for manufacturing an excrement treatment material according to claim 12,
wherein in the electrifying treatment step, the packaging bag is electrified such that the charge amount of the inner surface is twice or more of the charge amount of the outer surface.

14. The method for manufacturing an excrement treatment material according to claim 12,
wherein in the electrifying treatment step, the inner surface is electrified negatively.

15. The method for manufacturing an excrement treatment material according to claim 12,
wherein in the electrifying treatment step, the packaging bag is electrified such that the charge amount of the inner surface is 2 kV or more.

16. The method for manufacturing an excrement treatment material according to claim 12,
wherein in the electrifying treatment step, the packaging bag is electrified such that the charge amount of the outer surface is 1 kV or less.

17. The method for manufacturing an excrement treatment material according to claim 11,
wherein in the grain forming step, each of the grains is formed that contains an organic substance as a main material.

18. The method for manufacturing an excrement treatment material according to claim 17,
wherein in the grain forming step, each of the grains is formed that is made only of the organic substance.

19. The method for manufacturing an excrement treatment material according to claim 17,
wherein in the grain forming step, each of the grains is formed that contains papers as the main material.

20. The method for manufacturing an excrement treatment material according to claim 11,
wherein the grain forming step includes
a core portion forming step of forming a plurality of core portions in a granular shape, and
a coating portion forming step of forming a coating portion so as to cover each of the core portions formed in the core portion forming step.
